(19) United States
(12) Patent Application Publication
(10) Pub. No.: US 2024/0303108 A1
(43) Pub. Date: Sep. 12, 2024

(54) METHOD AND SYSTEM FOR ASSIGNMENT AND PRIORITIZATION OF TASKS IN DECENTRALIZED EXECUTION

(71) Applicant: JPMorgan Chase Bank, N.A., New York, NY (US)

(72) Inventors: Sriram GOPALAKRISHNAN, West New York, NY (US); Daniel BORRAJO, Pozuelo de alarcon (Madrid) (ES)

(73) Assignee: JPMorgan Chase Bank, N.A., New York, NY (US)

(21) Appl. No.: 18/118,529

(22) Filed: Mar. 7, 2023

(51) Int. Cl. G06F 9/48; G06N 7/01

(52) U.S. Cl. CPC G06F 9/4881; G06N 7/01

(57) ABSTRACT

A method for assignment and prioritization of tasks for satisfying deadlines in decentralized execution of tasks is provided. The method includes: receiving inputs that relate to a set of tasks, a set of agents, a set of goals, a set of priority levels that are assignable to each task, and a partial order plan that relates to ordering dependencies for performing and completing the tasks; determining a qualification function that relates to whether a particular task is performable by a particular agent; determining an availability function that relates to a respective availability of each agent during a particular time interval; and analyzing the partial order plan, the qualification function, and the availability function in order to obtain an assignment function that relates to a proposed set of assignments of tasks to agents and a prioritization function that relates to a proposed set of assignments of tasks to priority levels.

### BACKGROUND

### 1. Field of the Disclosure

This technology generally relates to methods and systems for task assignment and prioritization, and more particularly to methods and systems for assignment and prioritization of tasks with uncertain durations for satisfying deadlines in decentralized execution of tasks.

### 2. Background Information

Task assignment under execution uncertainty and temporal/resource constraints is a standard problem for many organizations. Existing approaches in the artificial intelligence (AI) planning & scheduling and operations research literature predominantly focus on dynamic controllability, and non-preemptive execution of tasks. Such solutions are appropriate for teams of agents under tight control requirements. However, in most organizations with human teams, once tasks have been assigned, humans tend to execute their assignments without a constant central oversight. For dynamic controllability, one needs constant central oversight to always be monitoring the agents for dynamically modifying the plans. This permanent oversight is seldom feasible, especially in multi-national teams and remote-work settings.

Organizations manage human teams to accomplish their goals by planning to complete a set of tasks within time and resource constraints. As an example, in the Agile methodology for software development, tasks are assigned to team members typically every two weeks. An example goal would be to build a website, and the associated tasks would include designing the interface, programming different pages, and testing. There would be dependencies among tasks, and goal priorities. Key characteristics of these type of planning & scheduling (P&S) tasks are: (1) uncertainty in task durations; (2) availability of team members; (3) task-specific qualifications (e.g., only a developer trained on Javascript programming can develop the front-end interface); and (4) there may be limited or no central-control during the execution, as people's tasks are assigned at the start of the planned period, and then control is local i.e. each person decides what to work on. In relation to this last characteristic, if a team member can work on a blocking task that is a prerequisite for other tasks, then they might preempt their current task to work on it. Once that is done, then they can resume working on the preempted task. In this way, that team member would unblock others who might be idly waiting because they are not qualified to do it.

An objective of a P&S solution is to compute a task-to-human assignment that considers the following: tasks dependencies, goal prioritization, makespan (i.e., deadline), resource constraints such as agent availability and qualifications, uncertain tasks duration, distributed control, and preemption capabilities of agents. Accordingly, there is a need for a method for assignment and prioritization of tasks with uncertain durations for satisfying deadlines in decentralized execution.

### SUMMARY

The present disclosure, through one or more of its various aspects, embodiments, and/or specific features or sub-components, provides, inter alia, various systems, servers, devices, methods, media, programs, and platforms for assignment and prioritization of tasks with uncertain durations for satisfying deadlines in decentralized execution.

According to an aspect of the present disclosure, a method for assignment and prioritization of tasks is provided. The method is implemented by at least one processor. The method includes: receiving, by the at least one processor, a first input that relates to a set of tasks; receiving, by the at least one processor, a second input that relates to a set of agents; receiving, by the at least one processor, a third input that relates to a set of goals; receiving, by the at least one processor, a fourth input that relates to a predetermined set of priority levels that are assignable to each task included in the set of tasks; receiving, by the at least one processor, a partial order plan that relates to a set of ordering dependencies for performing and completing the tasks included in the set of tasks; determining, by the at least one processor, a qualification function that relates to whether a particular task from among the set of tasks is performable by a particular agent from among the set of agents; determining, by the at least one processor, an availability function that relates to a respective availability of each agent from among the set of agents during a particular time interval; and analyzing, by the at least one processor, the partial order plan, the qualification function, and the availability function in order to obtain an assignment function and a prioritization function, wherein the assignment function relates to a proposed set of assignments of tasks to agents and the prioritization function relates to a proposed set of assignments of tasks to priority levels from among the set of priority levels.

The method may further include determining a preemption cost function that relates to an additional amount of time required for performing a particular task as a result of a preemption of the particular task. The analyzing may include analyzing the preemption cost function in conjunction with the analyzing of the partial order plan, the qualification function, and the availability function in order to obtain the assignment function and the prioritization function.

The method may further include applying a Tabu stochastic search algorithm to the assignment function and the prioritization function in order to calculate an assignment and prioritization of the set of tasks.

The partial order plan may be representable by a directed acyclic graph (DAG) within which each respective task from among the set of tasks has a corresponding node and each respective ordering dependency from among the set of ordering dependencies has a corresponding directed edge.

The method may further include applying a Monte Carlo Tree Search (MCTS) stochastic search algorithm to the DAG in order to calculate an assignment and prioritization of the set of tasks.

The method may further include using a simulation algorithm to generate, for each goal included in the set of goals, a respective sampled value of a stochastic function that relates to a respective completion time of each corresponding goal included in the set of goals.

The method may further include using the assignment function, the prioritization function, and the sampled values to calculate a score that indicates a weighted probability of a completion of the set of goals within a predetermined time interval.

The method may further include receiving a set of importance weights that corresponds to the set of goals, wherein each respective importance weight indicates a relative importance of a corresponding goal from among the set of goals. The using of the assignment function, the prioritization function, and the sampled values to calculate the score may include using the set of importance weights in conjunction with the assignment function, the prioritization function, and the sampled values to calculate the score.

According to another aspect of the present disclosure, a computing apparatus for assignment and prioritization of tasks is provided. The computing apparatus includes a processor, a memory, and a communication interface coupled to the processor and the memory. The processor is configured to: receive, via the communication interface, a first user input that relates to a set of tasks; receive, via the communication interface, a second input that relates to a set of agents; receive, via the communication interface, a third input that relates to a set of goals; receive, via the communication interface, a fourth input that relates to a predetermined set of priority levels that are assignable to each task included in the set of tasks; receive, via the communication interface, a partial order plan that relates to a set of ordering dependencies for performing and completing the tasks included in the set of tasks; determine a qualification function that relates to whether a particular task from among the set of tasks is performable by a particular agent from among the set of agents; determine an availability function that relates to a respective availability of each agent from among the set of agents during a particular time interval; and analyze the partial order plan, the qualification function, and the availability function in order to obtain an assignment function and a prioritization function, wherein the assignment function relates to a proposed set of assignments of tasks to agents and the prioritization function relates to a proposed set of assignments of tasks to priority levels from among the set of priority levels.

The processor may be further configured to determine a preemption cost function that relates to an additional amount of time required for performing a particular task as a result of a preemption of the particular task. The processor may be further configured to analyze the preemption cost function in conjunction with the analyzing of the partial order plan, the qualification function, and the availability function in order to obtain the assignment function and the prioritization function.

The processor may be further configured to apply a Tabu stochastic search algorithm to the assignment function and the prioritization function in order to calculate an assignment and prioritization of the set of tasks.

The partial order plan may be representable by a directed acyclic graph (DAG) within which each respective task from among the set of tasks has a corresponding node and each respective ordering dependency from among the set of ordering dependencies has a corresponding directed edge.

The processor may be further configured to apply a Monte Carlo Tree Search (MCTS) stochastic search algorithm to the DAG in order to calculate an assignment and prioritization of the set of tasks.

The processor may be further configured to use a simulation algorithm to generate, for each goal included in the set of goals, a respective sampled value of a stochastic function that relates to a respective completion time of each corresponding goal included in the set of goals.

The processor may be further configured to use the assignment function, the prioritization function, and the sampled values to calculate a score that indicates a weighted probability of a completion of the set of goals within a predetermined time interval.

The processor may be further configured to receive, via the communication interface, a set of importance weights that corresponds to the set of goals, wherein each respective importance weight indicates a relative importance of a corresponding goal from among the set of goals. The processor may be further configured to use the set of importance weights in conjunction with the assignment function, the prioritization function, and the sampled values to calculate the score.

According to yet another aspect of the present disclosure, a non-transitory computer readable storage medium storing instructions for assignment and prioritization of tasks is provided. The storage medium includes executable code which, when executed by a processor, causes the processor to: receive a first input that relates to a set of tasks; receive a second input that relates to a set of agents; receive a third input that relates to a set of goals; receive a fourth input that relates to a predetermined set of priority levels that are assignable to each task included in the set of tasks; receive a partial order plan that relates to a set of ordering dependencies for performing and completing the tasks included in the set of tasks; determine a qualification function that relates to whether a particular task from among the set of tasks is performable by a particular agent from among the set of agents; determine an availability function that relates to a respective availability of each agent from among the set of agents during a particular time interval; and analyze the partial order plan, the qualification function, and the availability function in order to obtain an assignment function and a prioritization function, wherein the assignment function relates to a proposed set of assignments of tasks to agents and the prioritization function relates to a proposed set of assignments of tasks to priority levels from among the set of priority levels.

When executed by the processor, the executable code may further cause the processor to: determine a preemption cost function that relates to an additional amount of time required for performing a particular task as a result of a preemption of the particular task; and analyze the preemption cost function in conjunction with the analyzing of the partial order plan, the qualification function, and the availability function in order to obtain the assignment function and the prioritization function.

When executed by the processor, the executable code may further cause the processor to use the assignment function and the prioritization function to calculate a score that indicates a weighted probability of a completion of the set of goals within a predetermined time interval.

When executed by the processor, the executable code may further cause the processor to: receive a set of importance weights that corresponds to the set of goals, where each respective importance weight indicates a relative importance of a corresponding goal from among the set of goals; and use the set of importance weights in conjunction with the assignment function and the prioritization function to calculate the score.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for assignment and prioritization of tasks with uncertain durations for satisfying deadlines in decentralized execution.

FIG. 4 is a flowchart of an exemplary process for implementing a method for assignment and prioritization of tasks with uncertain durations for satisfying deadlines in decentralized execution.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

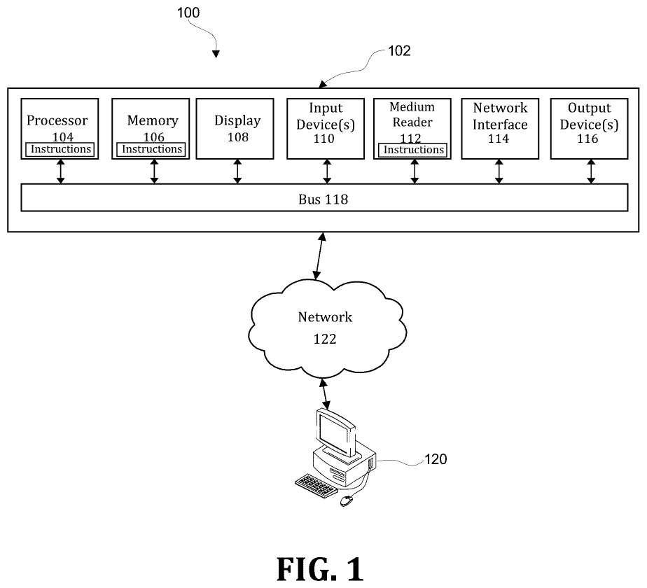

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for assignment and prioritization of tasks with uncertain durations for satisfying deadlines in decentralized execution.

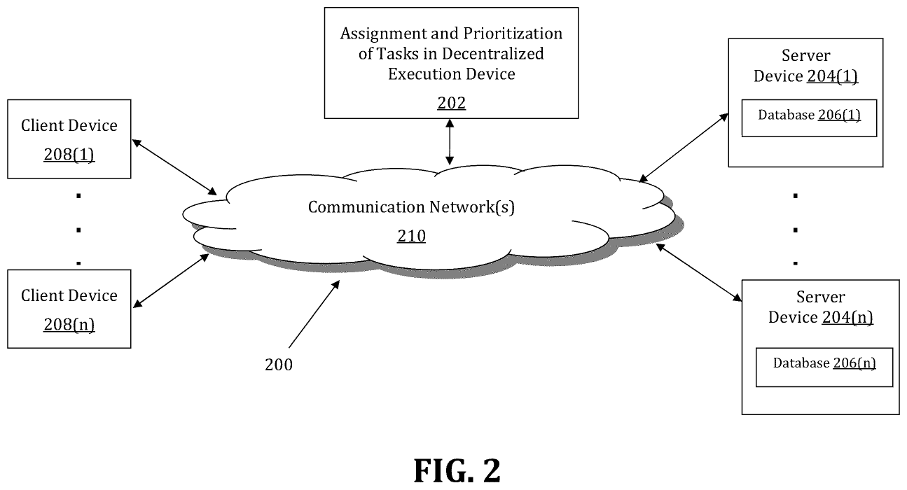

Referring to FIG. 2, a schematic of an exemplary network environment 200 for implementing a method for assignment and prioritization of tasks with uncertain durations for satisfying deadlines in decentralized execution is illustrated. In an exemplary embodiment, the method is executable on any networked computer platform, such as, for example, a personal computer (PC).

The method for assignment and prioritization of tasks with uncertain durations for satisfying deadlines in decentralized execution may be implemented by an Assignment and Prioritization of Tasks in Decentralized Execution (APTDE) device 202. The APTDE device 202 may be the same or similar to the computer system 102 as described with respect to FIG. 1. The APTDE device 202 may store one or more applications that can include executable instructions that, when executed by the APTDE device 202, cause the APTDE device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the APTDE device 202 itself, may be located in virtual server(s) running in a cloud-based computing environment rather than being tied to one or more specific physical network computing devices. Also, the application(s) may be running in one or more virtual machines (VMs) executing on the APTDE device 202. Additionally, in one or more embodiments of this technology, virtual machine(s) running on the DWS device 202 may be managed or supervised by a hypervisor.

In the network environment 200 of FIG. 2, the APTDE device 202 is coupled to a plurality of server devices 204(1)-204(n) that hosts a plurality of databases 206(1)-206(n), and also to a plurality of client devices 208(1)-208(n) via communication network(s) 210. A communication interface of the APTDE device 202, such as the network interface 114 of the computer system 102 of FIG. 1, operatively couples and communicates between the APTDE device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the APTDE device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and APTDE devices that efficiently implement a method for assignment and prioritization of tasks with uncertain durations for satisfying deadlines in decentralized execution.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The APTDE device 202 may be a standalone device or integrated with one or more other devices or apparatuses, such as one or more of the server devices 204(1)-204(n), for example. In one particular example, the APTDE device 202 may include or be hosted by one of the server devices 204(1)-204(n), and other arrangements are also possible. Moreover, one or more of the devices of the APTDE device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the APTDE device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to tasks, agents and/or personnel, and goals.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the APTDE device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the APTDE device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the APTDE device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the APTDE device 202, the server devices 204(1)-204(n), or the client devices 208(1)-208(n), for example, may be configured to operate as virtual instances on the same physical machine. In other words, one or more of the APTDE device 202, the server devices 204(1)-204(n), or the client devices 208(1)-208(n) may operate on the same physical device rather than as separate devices communicating through communication network(s) 210. Additionally, there may be more or fewer APTDE devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

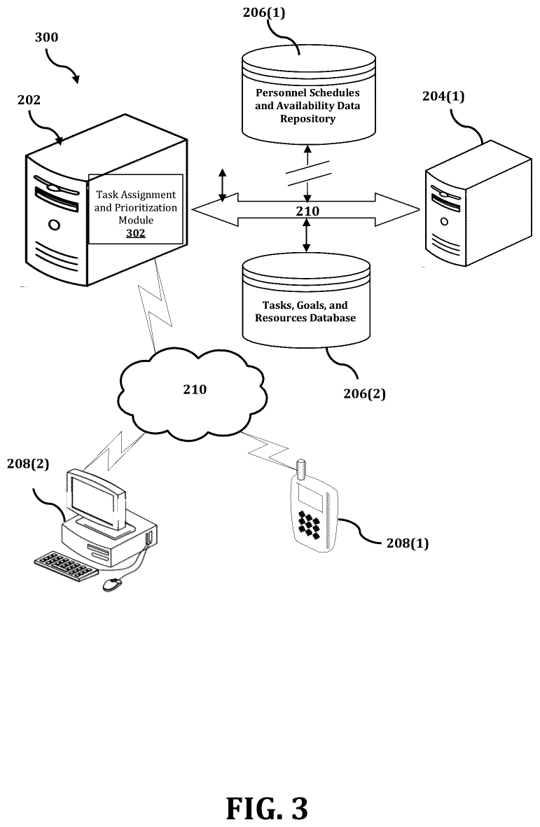

The APTDE device 202 is described and illustrated in FIG. 3 as including a task assignment and prioritization module 302, although it may include other rules, policies, modules, databases, or applications, for example. As will be described below, the task assignment and prioritization module 302 is configured to implement a method for assignment and prioritization of tasks with uncertain durations for satisfying deadlines in decentralized execution.

An exemplary process 300 for implementing a mechanism for assignment and prioritization of tasks with uncertain durations for satisfying deadlines in decentralized execution by utilizing the network environment of FIG. 2 is illustrated as being executed in FIG. 3. Specifically, a first client device 208(1) and a second client device 208(2) are illustrated as being in communication with APTDE device 202. In this regard, the first client device 208(1) and the second client device 208(2) may be “clients” of the APTDE device 202 and are described herein as such. Nevertheless, it is to be known and understood that the first client device 208(1) and/or the second client device 208(2) need not necessarily be “clients” of the APTDE device 202, or any entity described in association therewith herein. Any additional or alternative relationship may exist between either or both of the first client device 208(1) and the second client device 208(2) and the APTDE device 202, or no relationship may exist.

Further, APTDE device 202 is illustrated as being able to access a personnel schedules and availability data repository 206(1) and a tasks, goals, and resources database 206(2). The task assignment and prioritization module 302 may be configured to access these databases for implementing a method for assignment and prioritization of tasks with uncertain durations for satisfying deadlines in decentralized execution.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the APTDE device 202 via broadband or cellular communication. Of course, these embodiments are merely exemplary and are not limiting or exhaustive.

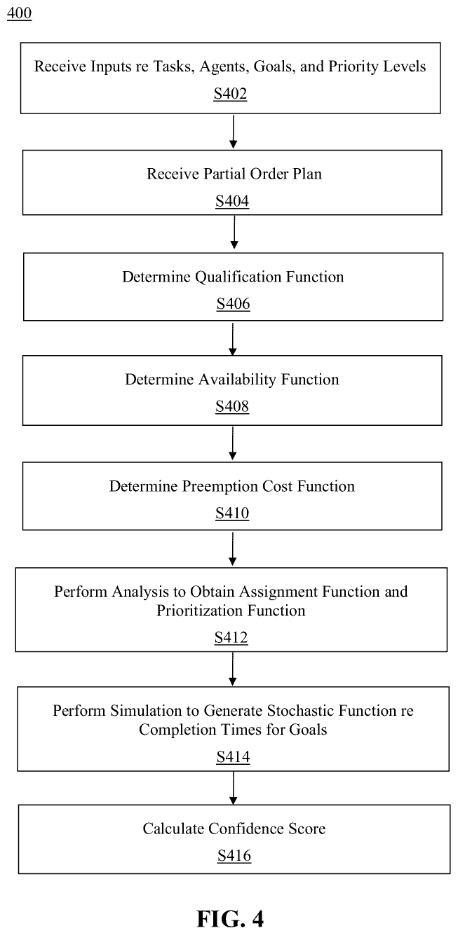

Upon being started, the task assignment and prioritization module 302 executes a process for assignment and prioritization of tasks with uncertain durations for satisfying deadlines in decentralized execution. An exemplary process for assignment and prioritization of tasks with uncertain durations for satisfying deadlines in decentralized execution is generally indicated at flowchart 400 in FIG. 4.

In process 400 of FIG. 4, at step S402, the task assignment and prioritization module 302 receives several inputs, including a first input that relates to a set of tasks, a second input that relates to a set of agents, a third input that relates to a set of goals, and a fourth input that relates to a predetermined set of priority levels that are assignable to each task included in the set of tasks. In an exemplary embodiment, the set of agents includes a list of personnel that are potentially qualified and available for performing one or more of the tasks included in the set of tasks. In an exemplary embodiment, the input that relates to a set of goals includes a set of importance weights that corresponds to the set of goals, where each respective importance weight indicates a relative importance of a corresponding goal included in the set of goals.

At step S404, the task assignment and prioritization module 302 receives a partial order plan that relates to a set of ordering dependencies for performing and completing the tasks included in the set of tasks. In an exemplary embodiment, the partial order plan is representable by a directed acyclic graph (DAG) within which each respective task from among the set of tasks has a corresponding node and each respective ordering dependency from among the set of ordering dependencies has a corresponding directed edge.

At step S406, the task assignment and prioritization module 302 uses the information received in steps S402 and S404 to determine a qualification function that relates to whether a particular task included in the set of tasks is performable by a particular agent included in the set of agents. Then, at step S408, the task assignment and prioritization module 302 uses that same information received in steps S402 and S404 to determine an availability function that relates to a respective availability of each agent for performing some task during a particular time interval.

At step S410, the task assignment and prioritization module 302 determines a preemption cost function that relates to an additional amount of time required for performing a particular task as a result of a preemption of that particular task.

At step S412, the task assignment and prioritization module 302 performs an analysis of the partial order plan, the qualification function, the availability function, and the preemption cost function in order to obtain an assignment function and a prioritization function. The assignment function relates to a proposed set of assignments of tasks to agents, and the prioritization function relates to a proposed set of assignments of tasks to priority levels. In an exemplary embodiment, the calculation of the assignment and prioritization of tasks is performed by applying a Tabu stochastic search algorithm on the information given to this process. In another exemplary embodiment, the assignment and prioritization of tasks is performed by applying a Monte Carlo Tree Search (MCTS) stochastic search algorithm on the information given to this process.

At step S414, the task assignment and prioritization module 302 uses a simulation algorithm to generate a sampled value of a stochastic function that relates to a respective completion time of each corresponding goal included in the set of goals based on the assignment function and prioritization function computed previously. In an exemplary embodiment, the sampled values may be used to guide the search algorithm that is used for the assignment and prioritization of tasks.

At step S416, the task assignment and prioritization module 302 uses the assignment function, the prioritization function, the sampled completion times, and possibly also the set of importance weights to calculate a confidence score that indicates a weighted probability of a completion of the set of goals within a predetermined time interval. In an exemplary embodiment, the calculated score provides a user with information that indicates a quality of the task assignment and prioritization output by the process.

In an exemplary embodiment, the term “tasks” refers to low-level activities that are similar to actions in a plan. In this aspect, a robust solution to the type of planning-and-scheduling (“P&S”) problems disclosed herein would increase the likelihood of task completion within a particular makespan or deadline.

Problem Definition: In an exemplary embodiment, a problem of Assignment and Prioritization of Tasks (APT) for Distributed Execution is given by the tuple <π,T,A,P,G,γ,w,m,δ,q,α,β> where: 1) π: Partial Order Plan represented by a directed acyclic graph (DAG=<T,E>) where Tis the set of vertices of the DAG, and correspond to the tasks in the plan, and the directed edges capture the ordering dependencies; 2) T: set of tasks; 3) A: set of agents; 4) P: fixed set of priority levels assignable to the actions, and P c Z⁺; 5) G: set of goals; 6) γ: G→2^{T}: tasks associated to each goal, where a goal is considered complete when all its tasks are done; 7) w: G→R⁺: importance weight (priority) of each goal, noting that this is different from the assignable task priority from P; 8)m∈R⁺ is the maximum makespan within which the goals ought to be completed; 9) δ:T×R⁺→[0,1] defines the probability of completing a task in a given amount of time; 10) q:A×T→{0,1}: qualification function; q(αᵢ,tⱼ)=1 if agent αᵢ can perform task tⱼ; 11) α:A×R⁺×R+→{0,1}: availability function; α(αᵢ,t₁,t₂)=1 if αᵢ is available between t₁ and t₂; and 12) β:A×T→R⁺ is the preemption cost function that tells how much additional time a task will take because it has been preempted.

In an exemplary embodiment, a solution (i.e., output) to the APT problem consists of finding an assignment function α:T→A and prioritization function ρ:T→P that fulfill the temporal and resource constraints given by n, q and a. In order to compare different solutions, a scoring function for goal completion is defined. The score of a plan is the weighted probability of goal completion within the maximum makespan (m). This is defined in Equation 1 below:

$${\sum }_{g ∈ G} \frac{w ( g )}{{\sum }_{{g}^{′} ∈ G} w ( {g}^{′} )} \times prob ( c ( g , α , ρ ) < m ) \qquad ( 1 )$$

where prob(.) returns the probability of an event, and c(.) is a stochastic function that returns the completion time of goal g for a given assignment and prioritization. c(.) is determined using a simulator of the execution process that is described below.

Solving APT Problems: In an exemplary embodiment, a search-based approach to solving APT is employed. To estimate the goodness of solutions, given the stochasticity of task durations, a simulator is used to sample and rollout execution trajectories for a given assignment and prioritization of tasks.

Simulator: In an exemplary embodiment, the simulator takes in the problem components and a potential solution, as given by a and p, and returns a sampled value of the c(.) function. The simulator samples durations for each task, and simulates execution. A discrete time simulator is used. A continuous-time simulator would be faster, but a discrete simulator implicitly considers the slack from human behavior like reading emails, and thus, it better fits the problem setting. At each step, the simulator determines which task an agent works on based on their backlog; backlog is the set of tasks ready and incomplete at that step. Tasks assigned to an agent as per α(.) appear on their backlog when task dependencies are completed.

The simulator includes certain key dynamics: 1) Completion time: when a task is assigned to an agent's backlog, it comes with its priority level, which is given by p, and the time required to complete the task, which is sampled using δ. 2) First in, first out (FIFO): when two tasks arrive to an agent's backlog with equal task priority as set by p, the agent works on the first task that arrived. If they arrive at the same time, then the order is arbitrary. 3) Agent availability: when an agent is working on a task, progress is made on the task only during the time when the agent is available, as given by α(.). When the agent is available, the time required to complete the task is decremented by one time-step of the simulator. 4) Preemption: when a higher-priority task enters the backlog, it will preempt the current task, which will then return to the backlog. The time needed for completion of the preempted task will increase, as per β.

The simulator returns the completion time of each goal in G. Completion times are used by the search algorithms to find good assignments and prioritizations of tasks. In an exemplary embodiment, all tasks are considered as being preemptible. Non-preemptible tasks can be easily supported by checks in the simulator. The rest of the methodology remains unchanged.

Search Algorithms: In an exemplary embodiment, two stochastic search approaches to solve APT problems are presented: Tabu search and Monte Carlo Tree Search (MCTS). Both use simulations to evaluate the value of a solution using Equation 1. In Tabu search, the algorithm starts with a random initial solution, and takes local improvement steps until no more improvements greater than a specified threshold are possible. The process is iterated, via random restart, for as many times as possible within a time limit. The Tabu list in Tabu search only keeps the solutions obtained at the end of each iteration.

For MCTS, the nodes at each level in the tree correspond to a partial assignment of tasks with priorities (i.e., a partial solution). Each successor node adds an assignment and a priority for a task. During MCTS search, the process steps through each node and recursively selects the best-child node based on the average reward of the node, having been initialized to zero (0); this is only if the node is already fully expanded. If the node is not yet fully expanded, i.e., only a subset of children have been evaluated, then a random node from the remaining children is selected to be opened. Each node is evaluated by random rollout, i.e., random assignments and prioritizations for the remaining tasks, subject to the qualification constraints. The reward at the leaf node (i.e., the end of a rollout) is the average score returned by 30 simulations of the complete solution obtained at the leaf node. This reward is backpropagated to each of the parent nodes, and the average reward is updated.

When the allowed time for search has expired, MCTS may not have opened a terminal node of the search tree, which would have all tasks assigned. In that case, the best leaf-node from amongst the nodes opened so far is selected; this would only have a partial assignment of tasks. The assignment is then completed by using a hill-climbing search for the remainder with no random restarts or Tabu list. This is needed because unlike MCTS for the games of Chess or Go, a complete solution is needed, and not just the next decision in the search tree, which would be insufficient.

In experiments, exploration with upper confidence bounds was not utilized. It was found that exploration resulted in worse solutions when limited by the cutoff time; this is attributable to MCTS taking more time to explore than to exploit/discern between good partial solutions that were found early.

One of the algorithmic decisions that helped improve results in MCTS was to order the task assignment decisions intelligently. In an exemplary embodiment, a topological sort on the partial-order plans DAG is performed, and the topology levels are used to order tasks in the search tree. The rationale is that decisions made for tasks (i.e., nodes) at lower topological levels would impact downstream decisions, so it makes more sense to decide these first. Additionally, since goals have importance weights associated to them, task assignments in MCTS are ordered based on the highest weight of the goals that require them.

Experiments: The Tabu and MCTS algorithms are evaluated on six (6) randomly generated APT problems. Each algorithm has a time limit of 30 minutes. The number of tasks in each plan is fixed to 30. So, a plan DAG with fewer levels/depth will have more tasks per topology level, thus resulting in a wider graph. The number of goals was randomly set between [3, 5], and each goal weight was randomly set between [1,3]. Each task from the last topological level was randomly assigned to one of the goals. The simulation time-step was 1 hour.

The following problem features were randomly generated: 1) Task Time: The time required per task is stochastic, and follows a uniform distribution between two limits. The limits are sampled from a normal distribution with a mean of 8 (hours), and standard deviation of 3; the smaller sampled value is the lower bound. 2) Agent Availability: Each agent is available during random intervals of time to make the search more challenging. The experiment starts with the agent being available for the maximum duration of a problem. Then, for each hour, the likelihood of an agent taking time off starting from any given hour is 0.05. If an agent takes time off, the duration is sampled from a Gaussian distribution with mean 8 and standard deviation 4. 3) Likelihood of Task Dependency: Each task has a 5% chance of being connected to any other task. This is in addition to of the single edge needed to enforce the depth of the DAG underlying the partial plan. 4) Qualifications: Each task requires a qualification to successfully perform and complete the task. Each agent is assigned a subset of the possible qualifications, with at least one agent having each qualification. The likelihood of an agent having an additional qualification is 0.25. The number of qualifications is fixed to 4.

The makespan m was set to 60% of the sum of all the tasks' duration upper bound. This value is set empirically based on results from using a team of 3 agents and 1 priority level; the score using Equation 1 was often below 50% with either search algorithm, so it was selected as being a challenging makespan. Given these variations in problem parameters, it is posited that the problem generation is sufficiently parameterized to produce diverse, and challenging problems.

During simulation of an assignment on a plan, when an agent's task is preempted by a higher priority task, the penalty is set to a fixed amount; 0.5 hours additional time to complete the preempted task. For these experiments, the following are variable: 1) topology of the underlying DAG: the depth is set to 3 or 6, which affects the longest sequence of dependencies; 2) number of agents: teams of 4 and 6 people are used; 3) priority levels: 1 and 3 priority levels are used in order to evaluate the effects of preemption. All code was written in python and experiments were run on a personal computer (PC) with Intel® Core™ i7-6700 CPU, running at 3.40 GHz on Ubuntu 20.04 with 32 GB of memory. All random elements are controlled by a seed.

Results: Table 1 below presents the results on 6 randomly generated problems, where each problem's data is separated into a sub-table.

TABLE 1
Likelihood of finishing execution by maximum makespan
for MCTS and Tabu search given different configurations
of topological depth (H), number of agents (a =
|A|), priority levels (p = |P|)) and maximum makespan (m)

| | | | | Goals | | | | | | |
|---|---|---|---|---|---|---|---|---|---|---|
| H | a | p | m | g₀ | g₁ | g₂ | g₃ | g₄ | MCTS | Tabu |
| 3 | 4 | 1 | 163 | 1 | 1 | 2 | 1 | 1 | 0.86 | 0.83 |
| 3 | 4 | 3 | 163 | 1 | 1 | 2 | 1 | 1 | 0.99 | 0.93 |
| 3 | 6 | 1 | 163 | 2 | 2 | 1 | 3 | 3 | 0.99 | 1.0 |
| 3 | 6 | 3 | 163 | 2 | 2 | 1 | 3 | 3 | 1.0 | 1.0 |
| 3 | 4 | 1 | 156 | 2 | 3 | 1 | | | 0.04 | 0.0 |
| 3 | 4 | 3 | 156 | 2 | 3 | 1 | | | 0.48 | 0.4 |
| 3 | 6 | 1 | 156 | 1 | 2 | 1 | 2 | 2 | 1.0 | 1.0 |
| 3 | 6 | 3 | 156 | 1 | 2 | 1 | 2 | 2 | 1.0 | 1.0 |
| 3 | 4 | 1 | 165 | 3 | 3 | 3 | 1 | 3 | 1.0 | 1.0 |
| 3 | 4 | 3 | 165 | 3 | 3 | 3 | 1 | 3 | 0.93 | 0.99 |
| 3 | 6 | 1 | 165 | 3 | 3 | 2 | | | 1.0 | 1.0 |
| 3 | 6 | 3 | 165 | 3 | 3 | 2 | | | 1.0 | 1.0 |
| 6 | 4 | 1 | 169 | 2 | 1 | 3 | | | 0.32 | 0.33 |
| 6 | 4 | 3 | 169 | 2 | 1 | 3 | | | 0.34 | 0.33 |
| 6 | 6 | 1 | 169 | 1 | 3 | 3 | | | 1.0 | 1.0 |
| 6 | 6 | 3 | 169 | 1 | 3 | 3 | | | 1.0 | 1.0 |
| 6 | 4 | 1 | 174 | 2 | 1 | 1 | | | 1.0 | 1.0 |
| 6 | 4 | 3 | 174 | 2 | 1 | 1 | | | 1.0 | 0.99 |
| 6 | 6 | 1 | 174 | 3 | 1 | 2 | | | 1.0 | 1.0 |
| 6 | 6 | 3 | 174 | 3 | 1 | 2 | | | 1.0 | 1.0 |
| 6 | 4 | 1 | 154 | 1 | 2 | 3 | 3 | | 0.51 | 0.59 |
| 6 | 4 | 3 | 154 | 1 | 2 | 3 | 3 | | 0.7 | 0.76 |
| 6 | 6 | 1 | 154 | 3 | 2 | 3 | 3 | | 1.0 | 0.84 |
| 6 | 6 | 3 | 154 | 3 | 2 | 3 | 3 | | 1.0 | 1.0 |

In Table 1, the score under the MCTS and Tabu columns is computed as per Equation 1, and the score represents the averaged result of 100 simulation runs. For 4 agents, when the number of priorities increases from 1 to 3, the success rate increases appreciably for both algorithms, except in one anomalous case which is attributable to the stochastic nature of the search. Having more priority levels alleviates the agent resource constraint. An example of this is when only one agent has a necessary qualification for many tasks, that agent becomes the bottleneck. By allowing preemption, that agent can switch tasks and improve outcomes. For example, in the second graph, there is an increase in the score from 4 agents with 1 priority level, to 4 agents and 3 priority levels. The reason for that is only one agent had the qualification required for 8 longer tasks. When the same partial plan was run with 6 agents, there were two more agents who had that qualification, and that helped the success rate jump to 1.0. Both MCTS and Tabu search performed comparably well, and so there is no definitive conclusion as to whether one is better than the other. It is unsurprising that with 6 agents, even with just 1 priority, both methods tend to find seemingly optimal score solutions, except for the last graph when Tabu search only finds a 1.0 score solution with 3 priority levels and not with 1 priority level.

Accordingly, with this technology, an optimized process for assignment and prioritization of tasks with uncertain durations for satisfying deadlines in decentralized execution is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for assignment and prioritization of tasks, the method being implemented by at least one processor, the method comprising:
receiving, by the at least one processor, a first input that relates to a set of tasks;
receiving, by the at least one processor, a second input that relates to a set of agents;
receiving, by the at least one processor, a third input that relates to a set of goals;
receiving, by the at least one processor, a fourth input that relates to a predetermined set of priority levels that are assignable to each task included in the set of tasks;
receiving, by the at least one processor, a partial order plan that relates to a set of ordering dependencies for performing and completing the tasks included in the set of tasks;
determining, by the at least one processor, a qualification function that relates to whether a particular task from among the set of tasks is performable by a particular agent from among the set of agents;
determining, by the at least one processor, an availability function that relates to a respective availability of each agent from among the set of agents during a particular time interval; and
analyzing, by the at least one processor, the partial order plan, the qualification function, and the availability function in order to obtain an assignment function and a prioritization function, wherein the assignment function relates to a proposed set of assignments of tasks to agents and the prioritization function relates to a proposed set of assignments of tasks to priority levels from among the set of priority levels.

2. The method of claim 1, further comprising determining a preemption cost function that relates to an additional amount of time required for performing a particular task as a result of a preemption of the particular task,
wherein the analyzing comprises analyzing the preemption cost function in conjunction with the analyzing of the partial order plan, the qualification function, and the availability function in order to obtain the assignment function and the prioritization function.

3. The method of claim 1, further comprising applying a Tabu stochastic search algorithm to the assignment function and the prioritization function in order to calculate an assignment and prioritization of the set of tasks.

4. The method of claim 1, wherein the partial order plan is representable by a directed acyclic graph (DAG) within which each respective task from among the set of tasks has a corresponding node and each respective ordering dependency from among the set of ordering dependencies has a corresponding directed edge.

5. The method of claim 4, further comprising applying a Monte Carlo Tree Search (MCTS) stochastic search algorithm to the DAG in order to calculate an assignment and prioritization of the set of tasks.

6. The method of claim 1, further comprising using a simulation algorithm to generate, for each goal included in the set of goals, a respective sampled value of a stochastic function that relates to a respective completion time of each corresponding goal included in the set of goals.

7. The method of claim 6, further comprising using the assignment function, the prioritization function, and the sampled values to calculate a score that indicates a weighted probability of a completion of the set of goals within a predetermined time interval.

8. The method of claim 7, further comprising receiving a set of importance weights that corresponds to the set of goals, wherein each respective importance weight indicates a relative importance of a corresponding goal from among the set of goals, and
wherein the using of the assignment function, the prioritization function, and the sampled values to calculate the score comprises using the set of importance weights in conjunction with the assignment function, the prioritization function, and the sampled values to calculate the score.

9. A computing apparatus for assignment and prioritization of tasks, the computing apparatus comprising:
a processor;
a memory; and
a communication interface coupled to the processor and the memory,
wherein the processor is configured to:
receive, via the communication interface, a first user input that relates to a set of tasks;
receive, via the communication interface, a second input that relates to a set of agents;
receive, via the communication interface, a third input that relates to a set of goals;
receive, via the communication interface, a fourth input that relates to a predetermined set of priority levels that are assignable to each task included in the set of tasks;
receive, via the communication interface, a partial order plan that relates to a set of ordering dependencies for performing and completing the tasks included in the set of tasks;
determine a qualification function that relates to whether a particular task from among the set of tasks is performable by a particular agent from among the set of agents;
determine an availability function that relates to a respective availability of each agent from among the set of agents during a particular time interval; and
analyze the partial order plan, the qualification function, and the availability function in order to obtain an assignment function and a prioritization function, wherein the assignment function relates to a proposed set of assignments of tasks to agents and the prioritization function relates to a proposed set of assignments of tasks to priority levels from among the set of priority levels.

10. The computing apparatus of claim 9, wherein the processor is further configured to determine a preemption cost function that relates to an additional amount of time required for performing a particular task as a result of a preemption of the particular task,
wherein the processor is further configured to analyze the preemption cost function in conjunction with the analyzing of the partial order plan, the qualification function, and the availability function in order to obtain the assignment function and the prioritization function.

11. The computing apparatus of claim 9, wherein the processor is further configured to apply a Tabu stochastic search algorithm to the assignment function and the prioritization function in order to calculate an assignment and prioritization of the set of tasks.

12. The computing apparatus of claim 9, wherein the partial order plan is representable by a directed acyclic graph (DAG) within which each respective task from among the set of tasks has a corresponding node and each respective ordering dependency from among the set of ordering dependencies has a corresponding directed edge.

13. The computing apparatus of claim 12, wherein the processor is further configured to apply a Monte Carlo Tree Search (MCTS) stochastic search algorithm to the DAG in order to calculate an assignment and prioritization of the set of tasks.

14. The computing apparatus of claim 9, wherein the processor is further configured to use a simulation algorithm to generate, for each goal included in the set of goals, a respective sampled value of a stochastic function that relates to a respective completion time of each corresponding goal included in the set of goals.

15. The computing apparatus of claim 9, wherein the processor is further configured to use the assignment function, the prioritization function, and the sampled values to calculate a score that indicates a weighted probability of a completion of the set of goals within a predetermined time interval.

16. The computing apparatus of claim 15, wherein the processor is further configured to receive, via the communication interface, a set of importance weights that corresponds to the set of goals, wherein each respective importance weight indicates a relative importance of a corresponding goal from among the set of goals, and
wherein the processor is further configured to use the set of importance weights in conjunction with the assignment function, the prioritization function, and the sampled values to calculate the score.

17. A non-transitory computer readable storage medium storing instructions for assignment and prioritization of tasks, the storage medium comprising executable code which, when executed by a processor, causes the processor to:
receive a first input that relates to a set of tasks;
receive a second input that relates to a set of agents;
receive a third input that relates to a set of goals;
receive a fourth input that relates to a predetermined set of priority levels that are assignable to each task included in the set of tasks;
receive a partial order plan that relates to a set of ordering dependencies for performing and completing the tasks included in the set of tasks;
determine a qualification function that relates to whether a particular task from among the set of tasks is performable by a particular agent from among the set of agents;
determine an availability function that relates to a respective availability of each agent from among the set of agents during a particular time interval; and
analyze the partial order plan, the qualification function, and the availability function in order to obtain an assignment function and a prioritization function, wherein the assignment function relates to a proposed set of assignments of tasks to agents and the prioritization function relates to a proposed set of assignments of tasks to priority levels from among the set of priority levels.

18. The storage medium of claim 17, wherein when executed by the processor, the executable code further causes the processor to:
determine a preemption cost function that relates to an additional amount of time required for performing a particular task as a result of a preemption of the particular task; and
analyze the preemption cost function in conjunction with the analyzing of the partial order plan, the qualification function, and the availability function in order to obtain the assignment function and the prioritization function.

19. The storage medium of claim 17, wherein when executed by the processor, the executable code further causes the processor to use the assignment function and the prioritization function to calculate a score that indicates a weighted probability of a completion of the set of goals within a predetermined time interval.

20. The storage medium of claim 19, wherein when executed by the processor, the executable code further causes the processor to:
receive a set of importance weights that corresponds to the set of goals, wherein each respective importance weight indicates a relative importance of a corresponding goal from among the set of goals; and
use the set of importance weights in conjunction with the assignment function and the prioritization function to calculate the score.
